(19) United States
(12) Patent Application Publication
(10) Pub. No.: US 2016/0282915 A1
(43) Pub. Date: Sep. 29, 2016

(54) THERMAL MITIGATION FOR MODULAR PORTABLE COMMUNICATION DEVICE

(71) Applicant: Motorola Mobility LLC, Chicago, IL (US)

(72) Inventors: Michael J. Lombardi, Lake Zurich, IL (US); Joseph L. Allore, Mundelein, IL (US); Nathan M. Connell, Glenview, IL (US)

(21) Appl. No.: 14/665,805

(22) Filed: Mar. 23, 2015

(51) Int. Cl. G06F 1/20

(52) U.S. Cl. CPC G06F 1/206

(57) ABSTRACT

A system and method for thermal mitigation in a portable electronic device provide an adaptive processor temperature threshold based on the presence or absence of a second device connected to the portable electronic device. In an embodiment, the processor is a multi-core processor, and one or more cores are dedicated to the control of the second device when the second device is connected to the portable electronic device.

### TECHNICAL FIELD

The present disclosure is related generally to mobile device heat reduction, and, more particularly, to a system and method of heat mitigation with respect to a modular portable communication device.

### BACKGROUND

The first microprocessor was introduced in 1971. It was a rudimentary device that operated at a clock rate of 740 kHz. By the end of the 1970s, processor clock speeds were over 10,000 kHz (10 MHz), and by the early 1990s, clock speeds of 66,000 kHz (66 MHz) were common. The early 2000s saw clock speeds reaching 3,800,000 kHz (3.8 GHz), and processor speeds continue to increase.

The increase in processor speed has been a boon to consumers, since as microprocessor speeds increase, the performance of the host electronic device increases as well. However, increased processor speeds also cause the processor to generate heat at a higher rate. The generated heat must be managed to enable user comfort as well as to prevent damage to the processor or other electronics. Ideally, the mass of the host device itself may provide an effective heat sink; however, with the continued miniaturization of portable devices, device mass is becoming a less effective heat sink than it once was.

This is especially true of modular devices, which have even less mass than full-function devices. For example, in a modular system, a device may include basic computing functionality and wireless communication capabilities, but may not include a camera function or a wireless speaker function. To serve the needs of various users, two secondary devices can be provided; the first secondary device may be a camera module and the second secondary device may be a wireless speaker module.

By using the primary device coupled to the appropriate secondary module, each user is able to create a device that is customized to meet their needs. However, in a modular system such as this, the device's light housing and structure provides very little heat sink capacity to absorb and carry away any excess processor-generated heat.

While the present disclosure is directed to a system that can eliminate certain shortcomings noted in this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art in the public domain. As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example configuration of device components with respect to which embodiments of the presently disclosed principles may be implemented;

FIG. 2 is view of a first device and a second device, showing the back of the first device and the back of the second device in accordance with an embodiment of the disclosed principles;

FIG. 3 is side view of the first device and the second device in accordance with an embodiment of the disclosed principles;

FIG. 4 is side view of the first device and the second device mated together via the back of the first device and the front of the second device in accordance with an embodiment of the disclosed principles;

FIG. 5 is side view of the first device and a third device mated together via the back of the first device and the front of the third device in accordance with an embodiment of the disclosed principles;

FIG. 6 is a cross-sectional view of the first device and the second device mated together via the back of the first device and the front of the second device, further showing thermal paths between the devices; and

FIG. 7 is a flowchart illustrating a process in accordance with an embodiment of the disclosed principles for modifying heat generation behavior of a device based on connection to a second device.

### DETAILED DESCRIPTION

Before presenting a fuller discussion of the disclosed principles, an overview is given to aid the reader in understanding the later discussion. As noted above, high performance portable electronic devices can be provided in a modular format to meet a wide range of user needs while also providing a light base device for users requiring only basic functions such as cellular and other wireless communications.

As also noted above, such light devices may have processors capable of generating more heat than the lightened device body can adequately dissipate if the processor is operated at its optimum speed. In an embodiment, a first device is configured physically and operationally to attach to and interact with a second device. The first device includes an applications processor which may consist of multiple cores. In some embodiments, the processor consists of both low-power cores and high-power cores.

The first device alone is thinner than the combination of devices, but this thinness produces a high concentration of heat transferring from the processor of the first device to the rear surface of the first device near the processor. Indeed, the heat generated by the processor in certain scenarios may be so high that the first device must reduce the speed of the processor to prevent the temperature of the device housing from surpassing a user comfort threshold.

When the first device is used by itself, all processing cores are used for the function of the first device. However, in an embodiment, when the second device is attached (docked) to the first device, the first device receives and maps an ID of the second device to reconfigure the first device processor to operate differently. For example, the thermal generation settings of the first device processor may be changed based on the size and material of the second device. More specifically, since the rear surface of the first device is in physical and thermal contact with the second device, the second device now acts as an additional heat sink with its own insulating properties.

Thus, for example, in the combined device, the first device processor may be permitted to operate at higher speeds and generate more heat than if it were operating without the second device present. In this or an alternative embodiment, with the second device attached to the first device, one or more processing cores from the first device's processor may be used for or dedicated to the control of the second device. This may provide higher functionality for the second device and may also allow the combination of devices to dissipate waste heat more effectively.

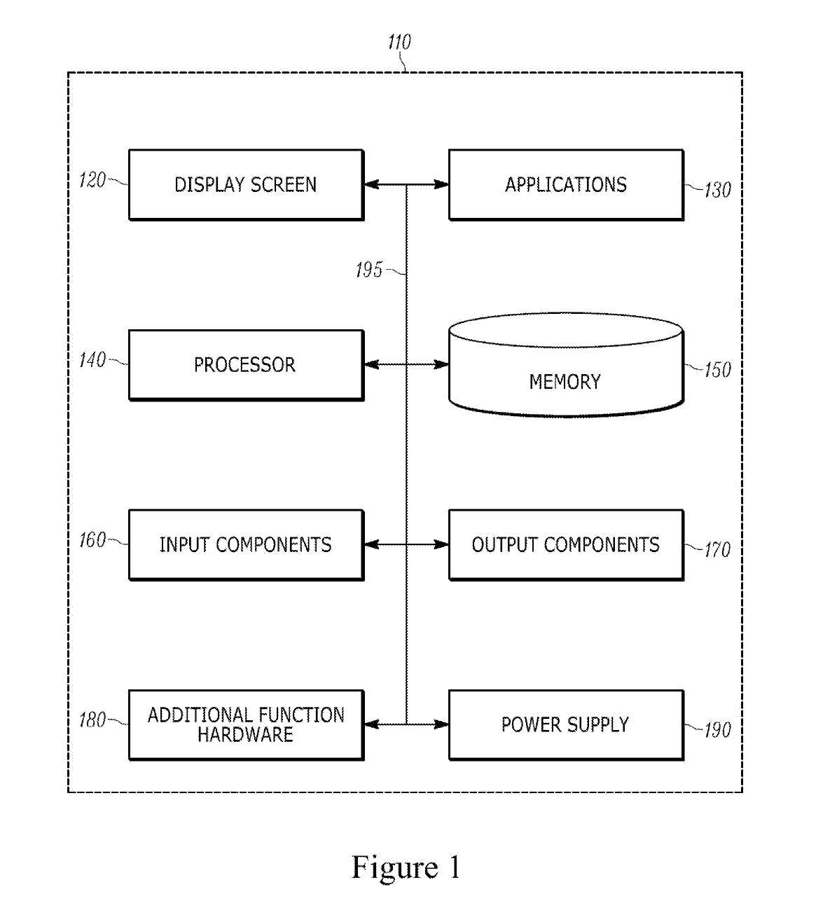

With this overview in mind, and turning now to a more detailed discussion in conjunction with the attached figures, the techniques of the present disclosure are illustrated as being implemented in a suitable computing environment. The following device description is based on embodiments and examples of the disclosed principles and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to personal computers, tablet computers and other devices.

The schematic diagram of FIG. 1 shows an exemplary component group 110 forming part of an environment within which aspects of the present disclosure may be implemented. In particular, the component group 110 includes exemplary components that may be employed in a device corresponding to the first device and/or the second device. It will be appreciated that additional or alternative components may be used in a given implementation depending upon user preference, component availability, price point, and other considerations.

In the illustrated embodiment, the components 110 include a display screen 120, applications (e.g., programs) 130, a processor 140, a memory 150, one or more input components 160 such as speech and text input facilities, and one or more output components 170 such as text and audible output facilities, e.g., one or more speakers.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

Finally, with respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device having component group 110 may include software and hardware networking components 180 to allow communications to and from the device. Such networking components 180 will typically provide wireless networking functionality, although wired networking may additionally or alternatively be supported.

In an embodiment, a power supply 190, such as a battery or fuel cell, may be included for providing power to the device and its components 110. All or some of the internal components 110 communicate with one another by way of one or more shared or dedicated internal communication links 195, such as an internal bus.

In an embodiment, the device 110 is programmed such that the processor 140 and memory 150 interact with the other components of the device 110 to perform certain functions. The processor 140 may include or implement various modules and execute programs for initiating different activities such as launching an application, transferring data, and toggling through various graphical user interface objects (e.g., toggling through various display icons that are linked to executable applications).

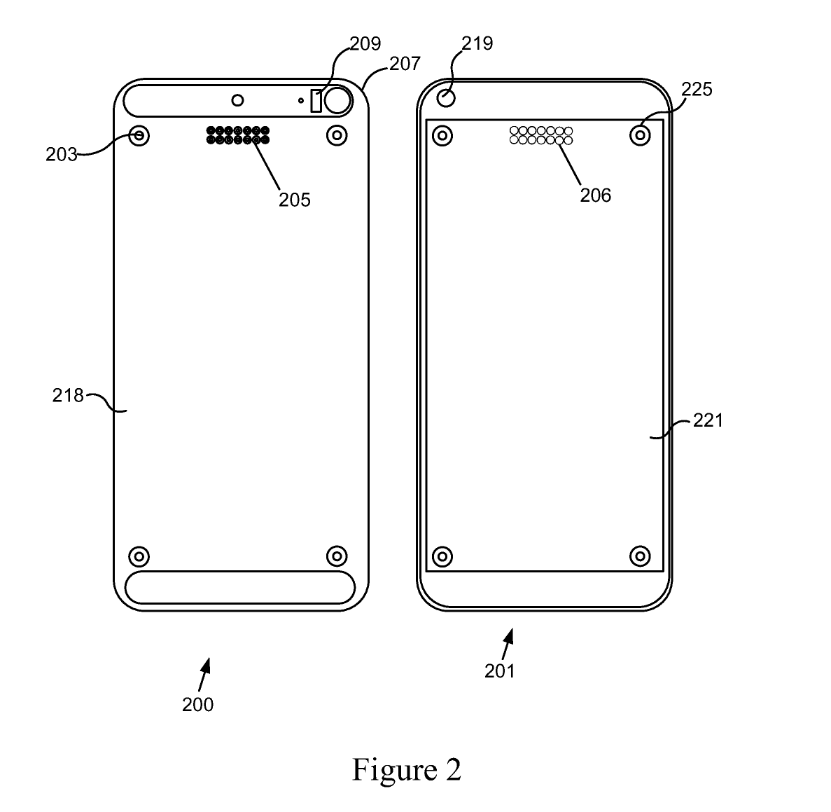

Turning to FIG. 2, this figure presents a view of a first device and a second device, showing the back of the first device and the back of the second device in accordance with an embodiment of the disclosed principles. In the illustrated example, the back 218 of the first device 200 includes one or more alignment features 203 configured and placed to mate with mating features 225 on the back 221 of the second device 201.

In addition, the back of the first device 200 in the illustrated embodiment includes a connector array 205. The connector array 205 is located and configured to mate with a mating connector array 206 on the back 221 of the second device 201. In the illustrated example, the back of the first device 200 further includes a built-in camera 207 and an associated flash 209. It will be appreciated that the first device 200 may include different features or additional features as compared to the illustrated embodiment.

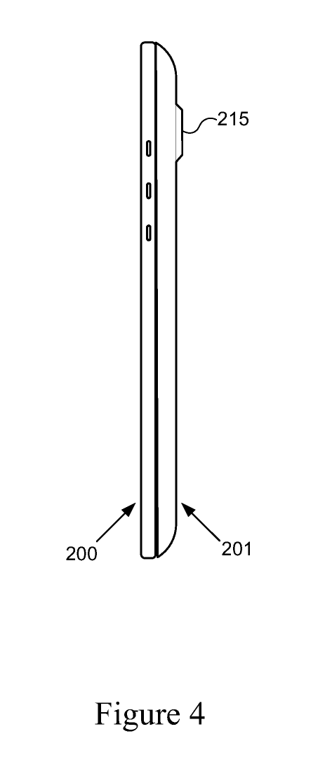

In the illustrated example, the second device 201 provides at least an enhanced camera function. To this end, the second device 201 includes on its front face a camera 215 (see FIG. 4) and an associated flash. Further, in the illustrated example, use of the camera 215 of the second device 201 does not preclude the use of the camera 207 of the first device 200. As such, a hole 219 is provided in the second device 201 to allow a sight line for the camera 207 of the first device 200.

In an embodiment, the first device 200 is configured via computer-executable instructions read from memory and executed by the processor, to maintain its processor operating speed and/or processor temperature below a first predetermined threshold value during stand-alone operation. The first predetermined threshold value is such that the surface temperature of the device housing remains below a temperature threshold allowing comfortable in-hand use of the device by a user.

When the second device 201 is physically and electronically coupled to the first device 200, the first device 200 detects the presence of the second device 201 and modifies its operation, to maintain processor operating speed and/or temperature below a second predetermined threshold value. While the second predetermined threshold value is typically higher than the first predetermined threshold value, the former may nonetheless keep the temperature of the user-accessible surface of the combined device below essentially the same temperature as the stand-alone device by accounting for the presence of the second device 201 acting as an additional heat sink.

Thus, with the devices 200, 201 joined together, the processor of the first device 200 may operate at a higher speed for a longer duration because the heat generated by it is dispersed across both devices 200, 201. It should be noted that the difference in speed and duration may vary depending upon characteristics of the second device 201. To this end, when the devices are joined, the processor of the first device 200 identifies not only the presence of the second device 201 but also a type of the second device 201. Thus, the new operating parameters can be made specific to the type of the second device 201, wherein the type represents thermally relevant aspects of the second device 201 such as size, thickness, and material composition.

Similarly, the processor in the first device 200 may operate with multiple cores when operating in a stand-alone configuration. When the second device 201 is attached to the first device 200, one or more cores of the processor may be dedicated to the control of the second device 201 by the first device 200 in an embodiment of the disclosed principles. Specifically, based on the type of the second device 201, the first device processor may alter the number of cores or type(s) of processing cores used to control the second device 201.

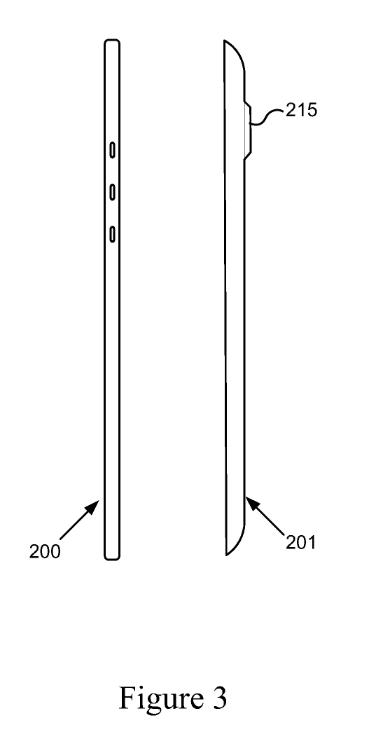

For further physical context regarding the device orientations and connection scenarios, FIG. 3 is a side view of the first device 200 and the second device 201, not yet mated together. Continuing, FIG. 4 is a side view of the first device 200 and the second device 201 mated together at the back of the first device 200 and the front of the second device 201 in accordance with an embodiment of the disclosed principles. As can be seen, the devices 200, 201 are in physical contact when mated. In should be noted that different embodiments of either device 200, 201 may vary significantly in thickness and shape from one another.

As noted above, when the second device 201 is attached to the first device 200, the first device 200 reads a device ID from, or associated with, the second device 201. The first device 200 maps the device ID to a device type, and modifies its behavior based on the device type of the second device 201 to account for the extent to which the second device 201 will alter the thermal behavior of the device 200.

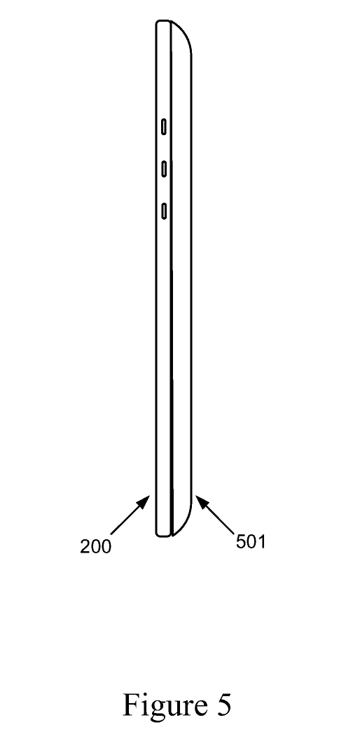

Before proceeding with a discussion of specific embodiments of the operation alteration process, it should be noted that the second device 201 may be any one of multiple available device types. For example, while FIGS. 2-4 illustrate the second device 201 as providing a camera function, FIG. 5 shows the first device 200 mated to an alternative second device 501, also referred to herein as a third device. The third device 501 is similar to the second device 201 but lacks a camera. The third device 501 may also incorporate one or more other features not found on the second device 201, such as additional battery capacity, wireless capabilities, audio playback capabilities, and so on.

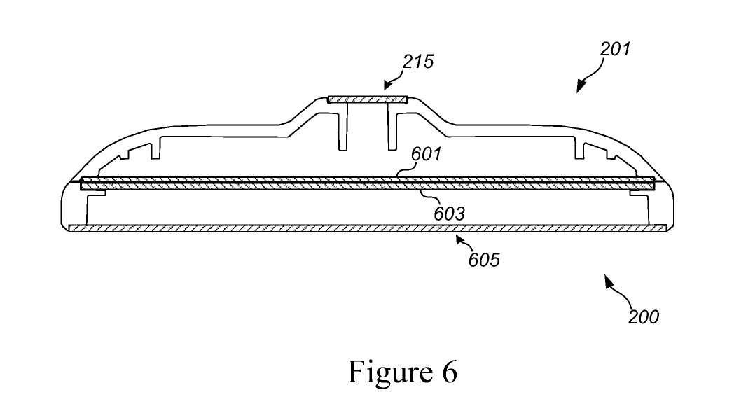

It will be appreciated that the first and second devices 200, 201 (501) need not be formed or configured precisely as described in the foregoing examples, and that various device behavior modifications may be made, including or instead of those described above. Though not required, it will generally be the case that the processors of both devices are located close to an exterior wall or housing of the device to optimize heat transfer to the surrounding air or material. These walls in turn are situated adjacent to each other, whether actually touching or not, when the devices 200, 201 are docked together. An example housing configuration is shown in cross-section in FIG. 6.

As can be seen, the first device 200 includes a rear surface 218, and second device 201 includes a rear surface 221. When the devices 200, 201 are docked together, the rear surface 218 of the first device 200 is adjacent to the rear surface 221 of the second device 201. The majority of the rear surface 221 of the second device 201 is created by a thermally conductive housing 601 and the majority of the rear surface 218 of the first device 200 is created by another thermally conductive housing 603. In the illustrated embodiment, the first device 200 further includes a touchscreen 605, while the second device 201 includes a camera 215. In an embodiment, rather than being a fully planar element, the thermally conductive housing 603 may form a single part with the sidewalls of the device 200.

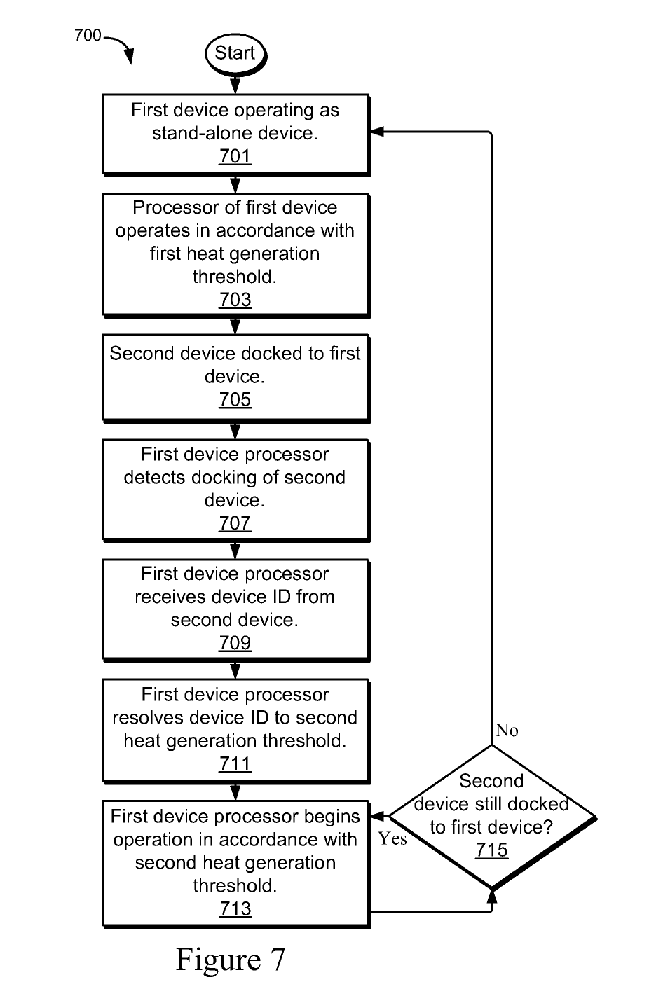

Regardless of the particular device configurations, FIG. 7 illustrates an example process 700 executed by the processor of the first device 200 based on the presence of the second device 201. At stage 701 of the process 700, the first device 200 operates as a stand-alone device. In this state, the processor of the first device 200 operates in accordance with a first heat generation threshold at stage 703, limiting the amount of heat that the processor is allowed to generate. In an embodiment, the first heat generation threshold comprises a temperature threshold value, e.g., a maximum temperature or average temperature above which the processor may not run. The processor temperature limit will be based on empirical data as to the relationship between processor temperature and the temperature of the device housing.

In order to operate in accordance with the first heat generation threshold, the processor of the first device slows its rate of operation when the threshold is reached in order to reduce heat generation. In an embodiment wherein the threshold specifies a maximum processor temperature, the rate at which the processor temperature approaches the threshold may be used to determine when or to what extent the processor should begin to slow its operation. For example, a high rate of approach may mandate that a reduction in processor speed takes place prior to the processor temperature actually reaching the threshold. Additionally or alternatively, a high rate of approach may indicate that a large reduction in speed should be undertaken when or before the threshold is reached.

At stage 705, a second device such as device 201 is docked or mated to the first device 200 as shown in FIG. 4. The processor of the first device 200 detects the docking of the second device 201 at stage 707, e.g., by detecting the connection of the mating contacts on the two devices 200, 201. The processor receives a device ID from the second device 201 at stage 709, e.g., via the mating contacts of the devices 200, 201. The device ID associated with the second device 201 may be unique to the second device 201 or may be associated with a class of devices having similar operational or thermal characteristics.

The received device ID is resolved to a second heat generation threshold comprising a set of one or more predetermined operational parameters at stage 711. In an embodiment, the set of one or more predetermined operational parameters includes a maximum processor operating speed and/or maximum processor temperature. The processor of the first device begins to operate in accordance with the second heat generation threshold at stage 713, and periodically determines at stage 715 whether the second device 201 remains docked to the first device.

If the first device processor detects at stage 715 that the second device 201 is no longer connected to the first device 200, e.g., by sensing disconnection via the mating connector array of the device 200, then the process 700 returns to stage 701 and the first device 200 again operates in accordance with the first heat generation threshold.

In this way, the first device 200 exploits the additional heat sink capacity of the second device 201 while the devices remain connected, but automatically reverts to operate in accordance with the more stringent first heat generation threshold when the second device 201 is no longer physically connected to the first device 200 to act as a heat sink.

In an embodiment, the processor of the first device 200 is configured to modify its operation and control strategy when the second device 201 is docked or attached. For example, the first device processor may be an application processor consisting of multiple cores. The processor may include both low-power cores and high-power cores. Further, in an embodiment, when the first device 200 operates in a stand-alone mode, all processing cores are used for the function of the first device 200.

However, when the second device 201 is docked to the first device 200, the first device receives and maps an ID of the second device to reconfigure the first device processor to operate differently. For example, one or more processing cores from the first device's processor may be used for or dedicated to the control of the second device 201. This shift may provide higher functionality for the second device and may allow the combination of devices to dissipate waste heat more effectively.

With respect to mapping a device ID to a set of operational parameters, whether pertaining to processor control strategy, processor temperature and/or clock speed, the received ID may be mapped by referencing a table or array stored in local or remote memory. In an embodiment, the device ID itself contains all or some of the predetermined parameters so that a further look-up or calculation is not required.

It will be appreciated that a system and method for thermal mitigation in a modular portable device have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A portable electronic device, the portable electronic device comprising:
a processor;
a temperature sensor configured to sense a temperature associated with the processor;
a back surface; and
a connector array exposed via the back surface, wherein the processor is configured to operate in one of a first heat generation mode, wherein the temperature associated with the processor is limited to a first temperature value, and a second heat generation mode, wherein the temperature associated with the processor is limited to a second temperature value, the processor being further configured to switch from the first heat generation mode to the second heat generation mode when a second device is connected to the portable electronic device at the connector array.

2. The portable electronic device in accordance with claim 1, wherein the back surface is configured such that connection of the second device to the first device at the connector array places a surface of the second device adjacent to the back surface.

3. The portable electronic device in accordance with claim 1, wherein the first temperature value is lower than the second temperature value.

4. The portable electronic device in accordance with claim 1, wherein the processor is further configured to receive a device ID from the second device when the second device is connected to the portable electronic device at the connector array.

5. The portable electronic device in accordance with claim 4, wherein the processor is further configured to set the second temperature value based on the device ID received from the second device when the second device is connected to the portable electronic device at the connector array.

6. The portable electronic device in accordance with claim 1, wherein the processor contains multiple processing cores.

7. The portable electronic device in accordance with claim 6, wherein the processor is further configured to operate using one or more of the cores when the second device is not connected to the portable electronic device at the connector array.

8. The portable electronic device in accordance with claim 6, wherein the processor is further configured to use one or more of the processing cores of the processor to control the second device when the second device is connected to the portable electronic device at the connector array.

9. A method of operating a portable electronic device having a processor, a temperature sensor configured to sense a temperature associated with the processor, a back surface, and a connector array exposed via the back surface, the method comprising:
operating the processor in one of a first heat generation mode, wherein the temperature associated with the processor is limited to a first temperature value, and a second heat generation mode, wherein the temperature associated with the processor is limited to a second temperature value;
switching from the first heat generation mode to the second heat generation mode when a second device is connected to the portable electronic device at the connector array; and
switching from the second heat generation mode to the first heat generation mode when the second device is disconnected from the portable electronic device at the connector array.

10. The method in accordance with claim 9, wherein the first temperature value is lower than the second temperature value.

11. The method in accordance with claim 9, further comprising receiving a device ID from the second device when the second device is connected to the portable electronic device at the connector array.

12. The method in accordance with claim 11, wherein the processor is further configured to set the second temperature value based on the device ID received from the second device when the second device is connected to the portable electronic device at the connector array.

13. The method in accordance with claim 9, wherein the processor contains multiple processing cores and wherein operating the processor in the first heat generation mode comprises operating using one or more of the processing cores.

14. The method in accordance with claim 9, wherein the processor contains multiple processing cores and wherein operating the processor in the second heat generation mode comprises using one or more of the processing cores to operate the second device.

15. A method of thermal mitigation in a portable electronic device having a processor, the method comprising:
operating the processor in a first heat generation mode to limit its temperature to a first heat threshold when the portable electronic device is operating as a standalone device; and
operating the processor in a second heat generation mode to limit its temperature to a second heat threshold when the portable electronic device is physically and electrically connected to a second device.

16. The method in accordance with claim 15, further comprising detecting, when the portable electronic device is operating in the first heat generation mode, that the second device has been connected to the portable electronic device and in response, switching from the first heat generation mode to the second heat generation mode.

17. The method in accordance with claim 15, further comprising detecting, when the portable electronic device is operating in the second heat generation mode, that the second device has been disconnected from the portable electronic device and in response, switching from the second heat generation mode to the first heat generation mode.

18. The method in accordance with claim 16, wherein detecting that the second device has been connected to the portable electronic device further comprises receiving a device ID at the portable electronic device from the second device.

19. The method in accordance with claim 16, wherein switching from the first heat generation mode to the second heat generation mode further comprises selecting the second heat threshold based on the received device ID.

20. The method in accordance with claim 15, wherein the processor contains multiple processing cores and wherein operating the processor in the second heat generation mode comprises using one or more of the processing cores to operate the second device.
